(19) United States
(12) Patent Application Publication
(10) Pub. No.: US 2007/0139376 A1
(43) Pub. Date: Jun. 21, 2007

(54) Computer mouse

(76) Inventor: Susan L. Giles, San Mateo, CA (US)

Correspondence Address: Paul K Tomita;Dergosits & Noah, Suite 1450, Four Embarcadero Center, San Francisco, CA, 94111, US

(21) Appl. No.: 10/588,462

(22) PCT Filed: Oct. 7, 2004
(86) PCT No.: PCT/US04/33094

§ 371 Date: Jun. 21, 2006

Related U.S. Application Data
(60) Provisional application No. 60/509,767, filed on Oct. 7, 2003.

(51) Int. Cl. G09G 5/08

(52) U.S. Cl. 345/163

(57) ABSTRACT

The mouse computer input device (401) only outputs left button switch (109) signals to the application program (321). The mouse body (401) and buttons form substantially hemispherical shape. The mouse buttons are activated with an inward force to the side surfaces of the buttons or a downward force to the top of the buttons. The system includes a special mouse driver (411) which recognizes the right button switch (129) signal but outputs a left button user interface signal to the application program (321). Thus, when the left and right mouse buttons are squeezed together, the driver outputs only a left button signal. The driver is controlled by an icon on the computer's desktop screen (323) and can be switched between one button and two button operation.

### FIELD OF THE INVENTION

This invention is related to an electro-mechanical mouse input device for a computer.

### BACKGROUND OF THE INVENTION

Mouse input devices for computers are well known in the art. The movement of the mouse in an X-Y plane typically actuates a mechanical, optical or electrical device within the mouse that produces X and Y position signals that are conveyed to the computer. The computer typically uses the mouse X and Y position signals to manipulate the display of the computer screen, allowing a user to control a program. A computer mouse also typically has one or more buttons which allow the user to further control a computer program. The mouse and mouse button allow the user to move a cursor or other pointing device to a specific area of the computer screen and depress the one or more buttons to activate specific computer program functions. The mouse buttons are actuated by pressing the button downward.

With the proliferation of home and school computers, people are becoming computer literate at earlier ages. Software companies are developing educational programs for use by young children. These programs require children to operate a computer mouse.

One of the problems associated with a computer mouse is that children have great difficulty with the combined action of positioning the mouse in the required X-Y coordinate while at the same time operating the one or more buttons. A computer mouse is typically designed for adult hands with buttons designed for adult fingers. When the adult computer mouse is used by small children, the coordinated mouse movement and button activation can be very difficult.

Some mouse designs have attempted to make the computer mouse more user-friendly; however, these designs are generally intended to reduce hand injuries including carpal tunnel syndrome. Examples of the ergonomic computer mouse include U.S. Pat. Nos. 5,726,683 and 5,576,733 which both provide mouse bodies shaped for a more natural user hand position. Although these inventions address the problem of repetitive stress for adult hands, they are not easily used by children. U.S. Pat. No. 6,323,843 discloses a computer mouse which is specifically sized for children's hands to simplify the coordination requirements of positioning the computer mouse and activating the buttons. U.S. Pat. No. 6,323,843 is hereby incorporated by reference.

### SUMMARY OF THE INVENTION

The present invention is a child's computer mouse for controlling a cursor and inputting information into a computer in combination with a special mouse system. The inventive computer mouse includes an internal position detection mechanism and two buttons that electrically actuate features of a computer program. The mouse body is substantially hemispherical in shape, and the two buttons are mounted adjacent to each other on a front portion of the mouse. The buttons are curved downward from the top to the front and sides of the mouse. The buttons are attached to hinges that are close to the top and center of the buttons that allow the buttons to rotate forward, sideways or horizontally. The hinges allow the buttons to be actuated by applying a downward force on the buttons or by a squeezing any side surface of the buttons. The squeezing action can be compression of the front and back of the mouse, compression of the sides of the mouse together or any combination, such as a diagonal motion between the side and back of the mouse.

The inventive mouse has two buttons. Typically, the mouse is used with a two button mouse driver which is a software program that converts the electrical signals from the mouse into user interface signals that are recognized by a computer application program. The drivers define the interactions of all computer hardware with the computer application program. Thus, the actuation of the left and right mouse buttons result in different user interface signals being transmitted to the computer depending upon the software program with which the mouse is being used. In general, the left button is used for basic operations and is required for proper operation of the program, while the right button is used for special commands and is generally not required to operate the program.

For children just learning to use a computer it is very difficult to differentiate the functions of the left and right mouse buttons. Because the left button is used most often, the inventive mouse disables the right button functionality and causes the right button to function like the left button. Because both buttons produce the same output, the inventive mouse system transmits a left button signal to the application program in any of the following situations: left button clicked, right button clicked or left and right button are clicked simultaneously.

The left button can be clicked by pressing either button down or compressing either button with a horizontal movement. Squeezing the two buttons together also clicks the buttons. If the user is right handed, the thumb can be placed over the side of the left button and one or more fingers can be placed over the side of the right button. By squeezing the thumb and finger together, the mouse left and right buttons are clicked. This clicking of the two mouse buttons is distinct and advantageous over the known single button mouse which can only be actuated with a downward force on the single button.

This single button or left button output from to a two button mouse can be accomplished in various ways. In an embodiment, the inventive mouse is used with a one button mouse driver which causes the two button mouse to function as a single-button mouse. More specifically, pressing either the left button or the right button alone or simultaneously, results in the corresponding left or right button electrical signals being sent to the computer mouse driver. The one button mouse driver interprets the left and right button signals in the same way and responds by transmitting a left button user interface signal to the application program.

To switch the mouse back to the two button operation, a two button mouse driver can be reinstalled onto the computer. However, the mouse driver can also be switched between single button operation and two button operation without re-installing drivers. In this embodiment, the mouse driver is controlled by a can operate in either the single button mode or the two button mode. When a mode change signal from an input device is received, a program responds to this signal by switching the driver's mode of operation. This embodiment is useful when the mouse is used by both children and adults. The mouse driver can be switched to single button mode when the computer is used by children and switched to two button mode when the computer is being used by adults.

In yet another embodiment, the inventive mouse has an electrical switch which controls the operation of the mouse. The switch may be located on a surface or within the mouse body. In a first position, the switch causes the mouse to emit a left button electrical signal. The mouse driver transmits the left button user interface signal the computer application program when either the left button alone or the right button alone or both buttons are simultaneously are pressed. In a second position, the switch causes the mouse to function as a normal two button mouse. Pressing the left button results in the driver transmitting a left button digital signal to the application program and pressing the right button results in the driver transmitting a right button digital signal to the application program. In this embodiment, the mouse is used with a two button mouse driver. Because the operating mode of the mouse is controlled by hardware, there is no need to change the mouse driver when the mode of the mouse is switched.

### BRIEF DESCRIPTION OF THE DRAWINGS

The invention is herein described, by way of example only, with reference to embodiment of the present invention illustrated in the accompanying drawings, wherein:

FIG. 1 is a top view of the computer mouse;

FIG. 2 is a side view cutaway of the computer mouse;

FIG. 3 is a diagram of the computer mouse and computer; and

FIG. 4 is a diagram of an alternative embodiment of the computer mouse and computer.

### DETAILED DESCRIPTION

The following is a detailed description of the preferred embodiments of the present invention. However, the present invention is in no way intended to be limited to the embodiments discussed below or shown in the drawings. Rather, the description and the drawings are merely illustrative of the presently preferred embodiments of the invention.

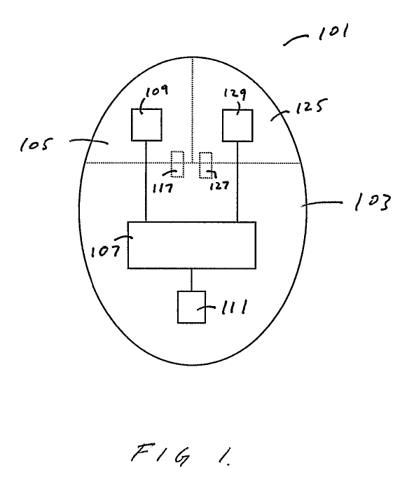

The mouse produces X and Y position signals that are related to the movement of the mouse as well as signals indicating that either of two switches are activated. A top view of the exemplary inventive mouse 101 is shown in FIG. 1. The mouse 101 comprises: a body 103, left button 105, left switch 109, right button 125, right switch 129, an optical motion sensor 111 and circuit board 131. The left button 105 has a left hinge 117 that is attached to the body 103 and allows the left button 105 to rotate down or sideways. The left button 105 contacts and actuates the left internal switch 109. The optical motion sensor 111, the left switch 109 and the circuit board 131 are within the mouse body 103. The inventive mouse has both a left button 105 that is connected to the left hinge 117 and a right button 125 that is connected to the right hinge 127. Movement of the left button 105 actuates the left switch 109 and movement of the right button 125 actuates the right switch 129.

When the mouse 101 is moved across a surface, the optical motion sensor 111 detects the movement and converts the X and Y movements of the mouse 101 into electrical signals. These electrical signals are transmitted to a computer through a flexible wire connection to either the mouse port, USB port or some other peripheral device connection. Alternatively, the mouse may have a wireless signal transmitter such as radio frequency or infrared light and an electrical power supply such as a rechargeable battery. In this configuration, a wireless receiver is used by the computer to receive the mouse wireless output signals.

An advantage of the inventive mouse is that it has a hemispherical shape and two buttons that curve around the periphery of the mouse that are actuated by multiple motions. The shape of the mouse allows small hands to cup the mouse and coordinate the mouse movement more easily than a larger conventional mouse. The curvature of the button surfaces allows actuation with a peripheral squeezing motion between any of the user's fingers and/or palm.

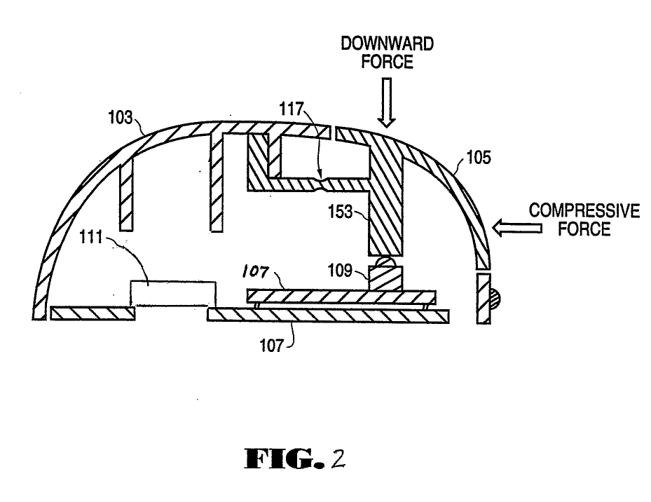

With reference to FIGS. 1 and 2, the buttons of the inventive mouse are large and have a substantially spherical surface that curves downward along the front and sides of the mouse. The buttons 105, 125 are attached to the mouse body 103 at hinges 117, 127 located just below the intersection of the body 103 and buttons 105, 125 at the top center of the mouse 101. The curved shape of the buttons 105, 125 and the position of the hinges 117, 127 allow the switches 109, 129 to be activated by applying various forces to the buttons 105, 125. The switches 109, 129 can be actuated by a downward at the top of the buttons 105, 125, a horizontal compressive force applied to any side of the buttons 105, 125 or a combination of vertical and horizontal forces. The horizontal compressive forces can be applied to the front or sides surfaces of the buttons 105, 125. For example, the sides of the buttons 105, 125 can be squeezed together to actuate both of the switches 109, 129.

As discussed, small hands of children can more easily activate the switches 109, 129 by squeezing the buttons 105, 125 horizontally, alternatively the buttons 105, 125 can also be moved with a downward force like other computer mice. With the mouse 101 placed between the hand's palm and fingers, a compressive force can be applied to the buttons 105, 125 to actuate the switches 109, 129. The sides of the mouse 101 are also curved and have vertically angled surfaces at the base, and any peripheral side of the mouse button can be squeezed to actuate the buttons 105, 125. These vertical side surfaces allow a hand's thumb and fingers to compress the side surfaces to actuate the buttons 105, 125.

When a child is learning to use a computer it is important to keep the operation of the mouse as simple as possible. The child first learns to control the movement of the mouse and then learns to control the actuation of the buttons. The two button mouse is problematic because it is difficult for a child to distinguish the different operations of the left and right buttons. The inventive computer mouse system simplifies the operation of the two button mouse so that the actuation of either the left or right buttons alone or simultaneously results in the computer application program receiving a left button signal.

This left mouse button only mode of operation is particularly useful when used with the children's mouse described in U.S. Pat. No. 6,323,843. This mouse has large buttons that actuate the electrical switches when the buttons are squeezed together in compression. When the user's hand is placed on the mouse, the thumb is naturally positioned over one of the buttons, and one or more of the opposing finger are positioned over the opposite button. The grasping or squeezing hand action is a simple motion that results in the actuation of the buttons 105, 125. As discussed above, when a horizontal force is applied to squeeze both the buttons 105, 125, the action will result in the actuation of both button switches 109, 129. When used with the single button driver, the actuation of both the buttons 105, 125 will result in the transmission of a left button “click” to the computer application program. Because the right button switch is not forwarded to the application program, the right click functionality of the application program is completely disabled. There are several ways that the operation of the mouse can be altered so that the actuation of the left and right buttons individually or simultaneously results in a left button user interface signal being transmitted to the application program.

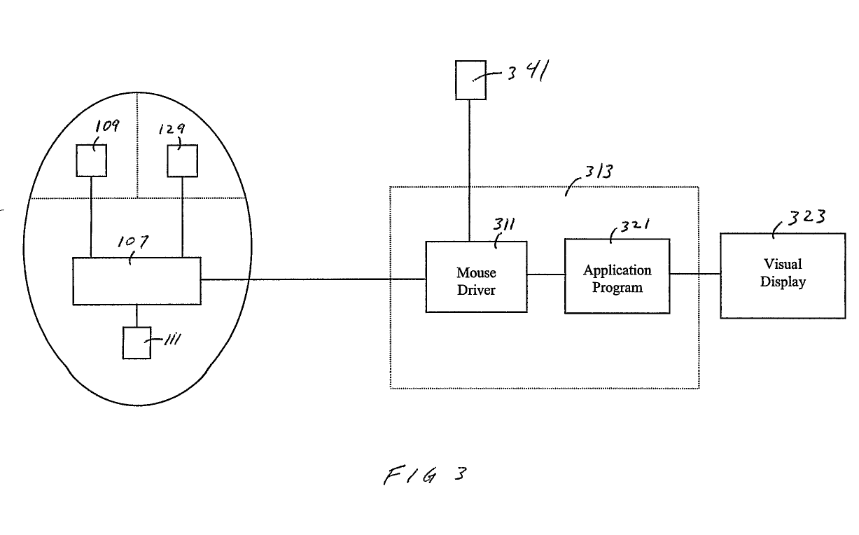

With reference to FIG. 3, the connection between the mouse 101 and the computer 313 is illustrated. The mouse 101 includes a left button switch 109, a right button switch 129, an optical position mechanism 111 and an integrated circuit 107. The integrated circuit 107 receives signals from the left button switch 109, right button switch 129 and optical position mechanism 111. The mouse 101 transmits these data signals to the mouse driver 311 software on the computer 313. The mouse driver 311 is the interface between the mouse 301 and the computer application program 321 which interprets the data signals and transmits commands which represent the mouse data signal to the computer application program 321. The computer application program 321 generally outputs a visual display 323 which is viewed by the mouse 301 user. The computer application program 321 typically responds to the left button switch 109 or right button switch 129 signals in the same manner, by altering the visual display an a manner corresponding to the left button switch 109 only.

This one button driver is particularly useful for a child or a beginning computer user. These beginners may grasp both of the mouse buttons between the thumb and fingers. In order to actuate the left button, the user can simply press or squeeze either or both buttons. Because the buttons extend to the edges of the computer mouse, the user can actuate the buttons by squeezing the sides of the left and right buttons simultaneously between the thumb and forefinger.

The inventive two button mouse system which only outputs a left button user interface signal to the application program is an improvement over a normal single button mouse because there are more ways to actuate the mouse button switch. The buttons of the two button mouse are actuated by applying a downward force or a horizontal force to the surfaces of the buttons alone or a combination of these forces. The buttons can also be actuated by squeezing the adjacent buttons together.

In contrast, the single button mouse can only actuated with a downward compression force. The button actuation caused by squeezing the two button mouse together described above is not possible with the single button mouse. Because the single button mouse only has one button, the button is not actuated when the button is twisted or the sides of the button are compressed. Any movement other than a downward force does not actuate the mouse button switch.

This is an improvement over the single button mouse. The single button mouse only has a single button and this single button is only actuated by a downward force applied to the button. In contrast, the two button mouse used with the single button driver allows many more variations of movement to actuate the button including horizontal forces along the sides of the mouse and compression of the mouse buttons together. This single-button driver used with the two button mouse can be used until the user becomes coordinated enough to differentiate left and right button clicks.

In an embodiment, the two button mouse 101 is used with a special computer mouse driver 311. This mouse driver 311 recognizes the left button switch 109 and right button switch 129 signals but emits the same left mouse button user interface signal to the application program in response to either signal. More specifically, the special driver 311 recognizes signals from the right button switch 305 but responds by transmitting left button user interface signals to the application program 321. This driver 311 also recognizes the signals from the left button switch 303 and responds by transmitting left button user interface signals to the computer application program 321. If the driver 311 receives simultaneous signals from both the left and right button switches, it transmits a left button user interface signal to the application program 321. The right button signal functionality of the application program is completely removed.

In an alternative embodiment, the user can switch between the one button driver and the normal two button driver without reloading the driver. Again with reference to FIG. 3, the driver 311 switches modes of operation between the single left button operation described above and the normal two button operation when the driver receives a mode changing signal from an external source 341. In this embodiment, both drivers are loaded onto the computer, however the active driver is selected by the user. The external source 341 can be a dedicated switch, the mouse 101, keyboard, or the application program 321. For example, the signal from the mouse 101 may be a specific combination or sequence of signals. Alternatively, the mouse mode changing signal may be a hot key signal from the keyboard or even a signal from a mouse driver mode changing application program. The user can then select the one button mode when the mouse is used as a one-button mouse. When the user wants to change the mouse back to a two button mode of operation, the user can unselect the two button operation through the desktop toolbar.

The one-button driver is loaded onto the user's computer as follows. The driver software is received as on a disk and downloaded to the user's computer through the computer's disk drive unit. Alternatively, the user can download the driver software from a specific web site through the internet or the driver software can be sent as an attachment to the customer's computer by e-mail. The user then installs the driver software while the computer mouse is plugged into the computer. The installation results in an icon on the desktop toolbar of the computer. This means that the actuation of the left and right buttons operates as a one button mouse. In the one button mode, the young children can click the left button by squeezing the left and right buttons together which is an easier motion than normal vertical force mouse button clicking. This mode changing driver permits children of different ages to use the mouse as either a one-button mouse or a two-button mouse.

Although computers are typically configured with a single mouse, it is also possible to have two mice connected to the computer at the same time. For example, the first mouse may be a two button adult mouse connected to a USB or PS/2 port which uses a normal two button mouse driver. The second mouse is a two button child's mouse that is connected to the same computer through another USB or PS/2 port. The one button mouse driver for the second mouse is installed as described above but only works with the second mouse and does not in any way affect the adult mouse that is also connected to the computer. Once the one button mouse driver is installed, a mouse icon is placed on the desktop toolbar. By clicking on the icon, a program is started which displays a screen giving the user a choice of mouse operating modes. The user then selects the either the one button or the two button mouse operating mode through the graphical user interface using the mouse and/or keyboard. When the user selects the one button or the two button mouse operating mode, the program actuates the desired mouse driver functionality and the second mouse functions accordingly.

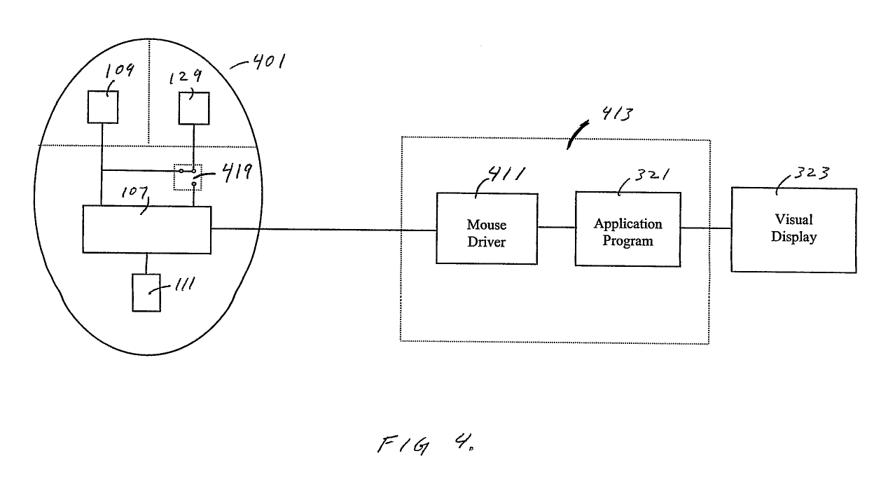

In some situations, it may be desirable to switch the operation of the mouse through hardware rather than altering the mouse driver to avoid altering software. With reference to FIG. 4, in this embodiment the mouse may include an electrical switch 419 which allows a user to manually change the mouse's mode of operation while using a normal two button mouse driver 411. In this embodiment, the mouse 401 includes: a left button switch 109, a right button switch 129, a mode switch 419, optical motion sensor and an integrated circuit 107. The mode switch 419 has two positions: “single button” and “two button.” The mode switch 419 alters the operation of the mouse 401 by changing the output path of the right button switch 129 to the left button switch 109.

In the single button setting as shown in FIG. 4, the mode switch 419 redirects the output of the right button switch 305 to the left button input of the integrated circuit 307. Thus, the integrated circuit 307 receives the same left button signal when the user actuates either the left button switch 303 or the right button switch 305. Similarly, if both the left button switch 303 or the right button switch 305 are actuated simultaneously, the integrated circuit 107 will only receive the left button switch signal. Thus, only left button signals are transmitted to the integrated circuit 107. Thus, the two button mouse driver 411 only receives left button switch signals and in response to these signals the driver 411 transmits left button user interface signals to the application program 321.

When the mode button is switched to the two button setting, the output of the right button switch 129 is shorted to the right button input of the integrated circuit 107, like a normal two button mouse. The integrated circuit 107 responds by transmitting the right buttons switch signal to the two button mouse driver 411. The two button mouse driver 411 receives the right buttons switch 129 signal and transmits a corresponding right button switch 129 user interface signal to the application program 321. Thus, the mouse 401 functions like the normal two button mouse used with a two button mouse driver when the mode switch 419 is switched to the two button position. Because the switching between one button and two button mode is done purely in the hardware, it is simpler to change the mode of operation with this embodiment of the mouse 401.

While the present invention has been described in terms of a preferred embodiment above, those skilled in the art will readily appreciate that numerous modifications, substitutions and additions may be made to the disclosed embodiment without departing from the spirit and scope of the present invention. For example, although the mouse has been described above for use with a computer, those skilled in the art will readily appreciate that the inventive computer mouse may be utilized in any similar electronic device and that the present invention is in no way limited to the mechanisms described above. It is intended that all such modifications, substitutions and additions fall within the scope of the present invention that is best defined by the claims below.

What is claimed is:

1. A computer mouse system for use with a computer application program comprising:
(a) a computer mouse having:
a position sensing mechanism;
a left mouse button, having a top, a front and a left side, that is actuated by a force applied to the top, the front or the left side of the button; and
a right mouse button, having a top, a front and a right side, that is actuated by a force applied to the top, the front or the right side of the button; and
(b) a mouse driver that generates a left button user interface signal and transmits the signal to the computer application program when the right button is actuated, or when the left and right buttons are actuated simultaneously.

2. The computer mouse system of claim 1, further comprising:
a computer readable disc which contains the computer code for the mouse driver.

3. The computer mouse system of claim 1, further comprising:
a left hinge that connects the left button to the mouse located proximate the top center of the mouse and a right hinge that connects the right button to the mouse located proximate the top center of the mouse.

4. The computer mouse system of claim 1, wherein the left side of the left button is vertically angled and a horizontal force applied to the left side of the left button actuates the left mouse button.

5. The computer mouse system of claim 4, wherein the right side of the right button is vertically angled and a horizontal force applied to the right side of the right button actuates the right mouse button.

6. The computer mouse system of claim 1, wherein the front surface of the left button is vertically angled and wherein a horizontal force applied to the front of the left button actuates the left mouse button.

7. The computer mouse system of claim 1, wherein the front surface of the right button is vertically angled and a horizontal force applied to the front of the right button actuates the right mouse button.

8. The computer mouse system of claim 1, wherein a lower edge of the left mouse button forms a continuous arc and any horizontal force directed towards the mouse applied proximate the lower edge of the left mouse button actuates the left mouse button.

9. The computer mouse system of claim 1, wherein a lower edge of the right mouse button forms a continuous arc and any horizontal force directed towards the mouse applied proximate the lower edge of the right mouse button actuates the right mouse button.

10. The computer mouse system of claim 1, wherein when a first horizontal force is applied to the left side of the left mouse button and a second horizontal force is applied to the right side of the right mouse button simultaneously, both the left mouse button and the right mouse button are actuated.

11. The computer mouse system of claim 1, further comprising:
a mode switching program on the computer that responds to a mode control signal by altering the operation of the mouse driver such that a right button user interface signal is generated and transmitted to the computer application program when the right button is actuated.

12. A computer mouse for use with a computer application program comprising:
a position sensing mechanism;
a left mouse button, having a top, a front and a left side, and a left button switch;
a right mouse button, having a top, a front and a right side; and a right button switch that is shorted to the electrical output of the left button switch such that the computer mouse transmits a left button actuation signal to the computer when the right button switch is actuated.

13. The computer mouse of claim 12, further comprising:
a left hinge that connects the left button to the mouse located proximate the top center of the mouse and a right hinge that connects the right button to the mouse located proximate the top center of the mouse.

14. The computer mouse of claim 12, wherein the left side of the left button is vertically angled and a horizontal force applied to the left side of the left button actuates the left mouse button.

15. The computer mouse of claim 14, wherein the right side of the right button is vertically angled and a horizontal force applied to the right side of the right button actuates the right mouse button.

16. The computer mouse of claim 12, wherein the front surface of the left button is vertically angled and wherein a horizontal force applied to the front of the left button actuates the left mouse button.

17. The computer mouse of claim 12, wherein the front surface of the right button is vertically angled and a horizontal force applied to the front of the right button actuates the right mouse button.

18. The computer mouse of claim 12, wherein a lower edge of the left mouse button forms a continuous arc and any horizontal force directed towards the mouse applied proximate the lower edge of the left mouse button actuates the left mouse button.

19. The computer mouse of claim 12, wherein a lower edge of the right mouse button forms a continuous arc and any horizontal force directed towards the mouse applied proximate the lower edge of the right mouse button actuates the right mouse button.

20. The computer mouse of claim 12, further comprising:
a mode switch connected to the right button that disconnects the right button switch from the left button switch such that a right button signal is transmitted to the computer when the right button is actuated.
